(19) United States
(12) Patent Application Publication
(10) Pub. No.: US 2006/0181161 A1
(43) Pub. Date: Aug. 17, 2006

(54) Actuator device

(75) Inventors: Makito Kawamoto, Kanagawa (JP); Masayuki Shimoyama, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Jidosha Denki Kogyo Co., Ltd., Kanagawa (JP)

(21) Appl. No.: 11/287,385

(22) Filed: Nov. 28, 2005

(30) Foreign Application Priority Data
Feb. 15, 2005 (JP) P.2005-037855

(51) Int. Cl. H02K 5/24; H02K 7/10; F16H 57/02

(52) U.S. Cl. 310/51; 74/606 R; 310/83

(57) ABSTRACT

The actuator device includes: a case having a motor housing unit and a gear housing unit; a motor housed in the motor housing unit; and an output gear rotatably housed in the gear housing unit of the case, the output gear driven to rotate by the driving shaft of the motor; the actuator device supporting the motor in a floatable fashion within the motor housing unit via an elastic element; characterized in that the elastic element includes a main body floating part for holding the motor main body of the motor and a pair of bearing floating parts for holding the bearings in front and rear of the driving shaft of the motor and that the main body floating part and the pair of bearing floating parts are integrally formed by way of an elastic element.

### BACKGROUND OF THE INVENTION

The present application claims foreign priority based on Japanese Patent Application No.2005-37855 filed on Feb. 15, 2005, the content of which is incorporated herein by reference in its entirety, and concurrently with the filing of this patent application.

The present invention relates to an actuator device preferably used for example in a steering lock device for locking/unlocking the steering shaft of a vehicle.

A related art steering lock device incluldes: a case having a cover that covers a motor housing unit and a gear housing unit; a motor housed in the motor housing unit of the case; an output gear rotatably housed in the gear housing unit of the case, the output gear driven to rotate via a deceleration gear by the driving shaft of the motor; an output shaft penetrated by and fixed to the shaft of the output gear and rotating together with the output gear; an output cam part mounted on the output shaft for locking/unlocking the steering shaft; and a pair of limit switches arranged in the gear housing unit of the case that is turned on/off by a cam part integrally formed on the shaft of the output gear.

As an actuator device used in this type of steeling lock device, one shown in FIGS. 16 and 17 is known (for example, refer to Patent reference 1).

The actuator device 1 includes: a case 2 having a cover (not shown) for covering a motor housing unit 2a and a gear housing unit 2b; a motor 3 housed in the motor housing unit 2a of the case 2; an output gear 6 rotatably housed in the gear housing unit 2b of the case 2, the output gear driven to rotate via a plurality of deceleration gears 5A, 5B, 5C by a worm 4b of a driving shaft 3 of the motor 3; an output shaft 7 penetrated by and fixed to the center of the output gear 6 and rotating together with the output gear 6; and sector gears (not shown) mounted on the output shaft 7 for locking/unlocking the steering shaft.

As shown in FIG. 17, the motor 3 has rubber O-rings 8a, 8b fitted to the bearings 3a, 3b in front and rear of the motor 3. Via these o-rings 8a, 8b the bearings 3a, 3b is brought into contact with the side walls of the motor housing unit 2a so as to support the motor 3 in the case 2. The tip 4a of the driving shaft 4 of the motor 3 is rotatably supported via a bent plate spring 9 as a bearing.

[Patent reference 1]

JP-A-9-215261

[Patent reference 2]

JP-A-2002-205622

[Patent reference 3]

JP-A-2002-326559

In the related art steering lock device 1, the motor 3 is simply held while being in contact with the side walls of the motor housing unit 2a of the case 2 via the rubber O-rings 8a, 8b fitted to the bearings 3a, 3b. Between the motor 3 and each side wall of the motor housing unit 2a of the case 2 is configured in floating support using an elastic member. As shown in FIG. 17, while the deceleration gear 5A is rotating, a reactive force F from the deceleration gear 5A acts on the driving shaft 4 of the motor 3, which causes the driving shaft 4 of the motor 3 to be bent in the direction of an arrow P about the bearing 3a. This is likely to cause a motor 20 to rattle between the side walls of the motor housing unit 2a thus being tilted (deviated). The reactive force F cannot be sufficiently absorbed only with the elastic force of the rubber O-rings 8a, 8b. Deformation or bending of the output of the motor 3 has sometimes resulted in poor engagement of the worm 4a of the output of the motor 3 with the deceleration gear 5A, thus causing malfunction and noise (operation noise).

In order to offset this disadvantage, a configuration is provided where an elastic member is arranged between the motor 3 and each side wall of the motor housing unit 2a of the case 2 for the purpose of floating support. This additionally requires an elastic member for floating support for the yoke part (motor main body) of the motor 3, on top of the rubber O-rings 8a, 8b fitted to the bearings 3a, 3b of the motor 3. This increases the number of parts to be assembled and man-hours, thus resulting in a higher cost.

### SUMMARY OF THE INVENTION

The invention is accomplished in order to solve the problems. An object of the invention is to provide an actuator device capable of performing floating support for an entire motor at low cost by using a simple structure as well as reliably preventing malfunction or noise caused by deformation of a motor driving shaft or deviation of a motor.

According to a first aspect of the invention, there is provided an actuator device including:

a case having a cover that covers a motor housing unit and a gear housing unit;

a motor housed in the motor housing unit of the case; and

an output gear rotatably housed in the gear housing unit of the case, the output gear driven to rotate by the driving shaft of the motor;

the actuator device supporting the motor in a floatable fashion within the motor housing unit via an elastic element, wherein

the elastic element includes:

a main body floating part for holding the motor main body of the motor, and

a pair of bearing floating parts for respectively holding the bearings in front and rear of the driving shaft of the motor,

the main body floating part and the pair of bearing floating parts being integrally formed by way of an elastic element.

According to a second aspect of the invention, there is provided the actuator device according to the first aspect, further including:

a notch formed between the main body floating part and at least one bearing floating part.

According to a third aspect of the invention, there is provided the actuator device according to the first or second aspect, further including:

a top piece, a bottom piece and side pieces connecting the top piece and the bottom piece are formed in the main body floating part, wherein

holes fitted to the bearings that rotatably support the driving shaft of the motor are formed in the pair of bearing floating parts.

According to a fourth aspect of the invention, there is provided the actuator device according to the third aspect, further including:

a pair of projections extending in the width direction of the motor main body of the motor integrally protruded above the top surface of the top piece, and

a pair of projections extending in the width direction of the motor main body of the motor integrally protruded below the bottom surface of the bottom piece.

As mentioned above, according to the first aspect of the invention, an elastic element supporting the motor in the motor housing unit in a floatable fashion is formed by a main body floating part for holding the motor main body of the motor and a pair of bearing floating parts for respectively holding the bearings in front and rear of the driving shaft of the motor and the main body floating part and the pair of bearing floating parts are integrally formed by way of an elastic element. This reduces the assembly man-hours and the overall cost as well as reliably supports the entire motor in a floatable fashion by using a simple structure. This reliably prevents malfunction or noise caused by deformation of a motor driving shaft or deviation of a motor.

According to the second aspect of the invention, a notch is formed between the main body floating part and at least one bearing floating part. It is thus possible to readily attach the main body floating part of the elastic element to the motor main body of the motor via the notch as well as readily attach the pair of beating floating parts of the elastic element to the bearings in front and rear of the driving shaft.

According to the second aspect of the invention, a top piece, a bottom piece and side pieces connecting the top piece and the bottom piece are formed in the main body floating part and holes fitted to the bearings that rotatably support the driving shaft of the motor are formed in the pair of bearing floating parts. The motor main body is embraced by the main body floating part and the pair of bearing floating parts, thereby supporting the motor main body more reliably in a floatable fashion.

According to the second aspect of the invention, a top piece, a pair of projections extending in the width direction of the motor main body of the motor is integrally protruded above the top surface of the top piece and that a pair of projections extending in the width direction of the motor main body of the motor is integrally protruded below the bottom surface of the bottom piece. It is thus possible to support the motor main body more reliably in a floatable fashion between the bottom wall in the motor housing unit 11a and the inner surface of the cover.

### BRIEF DESCRIPTION OF THE DRAWINGS

FIG. 1 is an exploded perspective view of a steering lock device according to an embodiment of the invention;

FIG. 2 is a cross section of the steering lock device;

FIG. 3 is a plan view of the case of the steering lock device;

FIG. 4 is an enlarged plan view of the output gear of the steering lock device and its periphery;

FIG. 5 is an enlarged cross section of the output gear of the steering lock device and its periphery;

FIG. 6 is an exploded perspective view showing the relationship between the case, a cover, a switch holder and a limit switch;

FIG. 7 is a plan view showing a state where a switch holder is temporarily attached to the case;

FIG. 8A is a cross section showing a state where a switch holder is temporarily attached to the case;

FIG. 8B is an enlarged cross section of a main part with the switch holder temporarily attached;

FIG. 9A is a general explanatory drawing of a mounting state where a, switch holder is sandwiched between the case and the cover;

FIG. 9B is an enlarged explanatory drawing of the main part in the mounting state;

FIG. 10 is a perspective view of a motor used in the steering lock device as seen obliquely from the front of the motor;

FIG. 11 is a perspective view of the motor as seen obliquely from the rear of the motor;

FIG. 12 is a plan view of the motor;

FIG. 13 is a side view of the motor;

FIG. 14 is a plan view of an elastic element attached to the motor;

FIG. 15 is a side view of the elastic element;

FIG. 16 is a plan view of the inside of the actuator device used as a related art steering lock device; and

FIG. 17 is a plan view of a motor supporting part of the related art actuator device.

### DETAILED DESCRIPTION OF THE PREFERRED EMBODIMENTS

An embodiment of the invention will be described based on drawings.

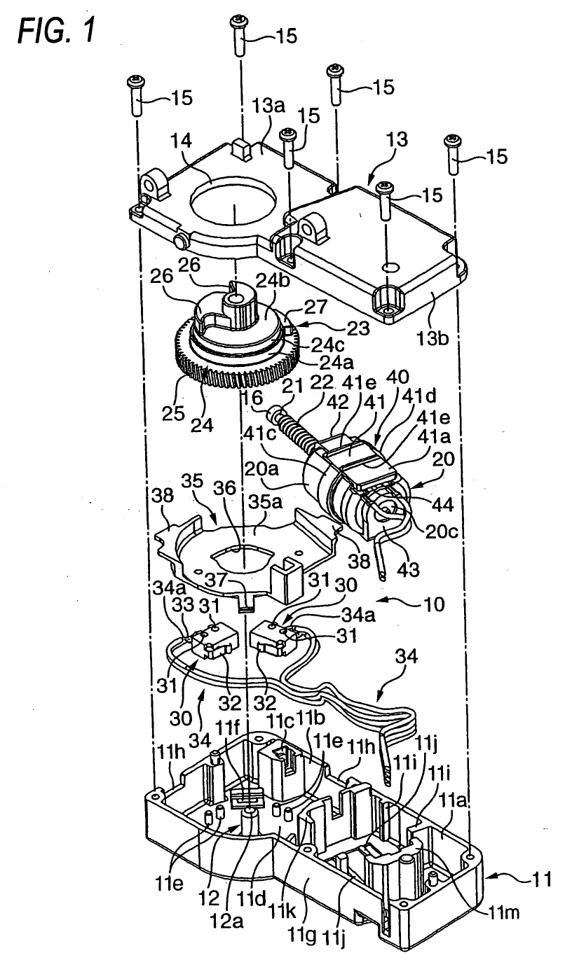

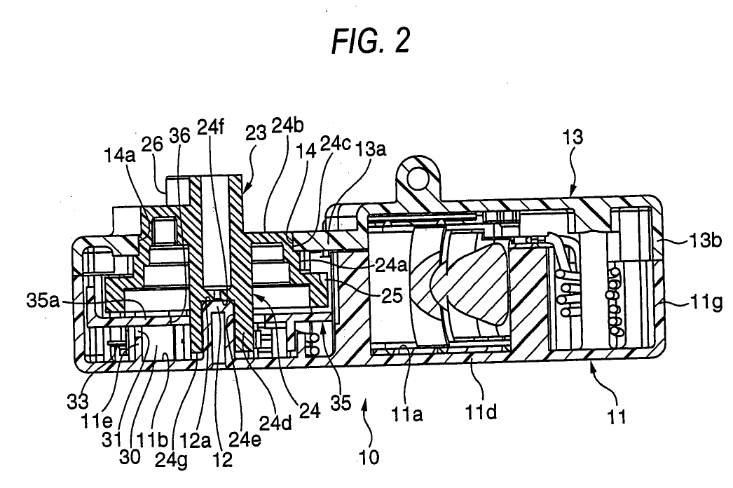

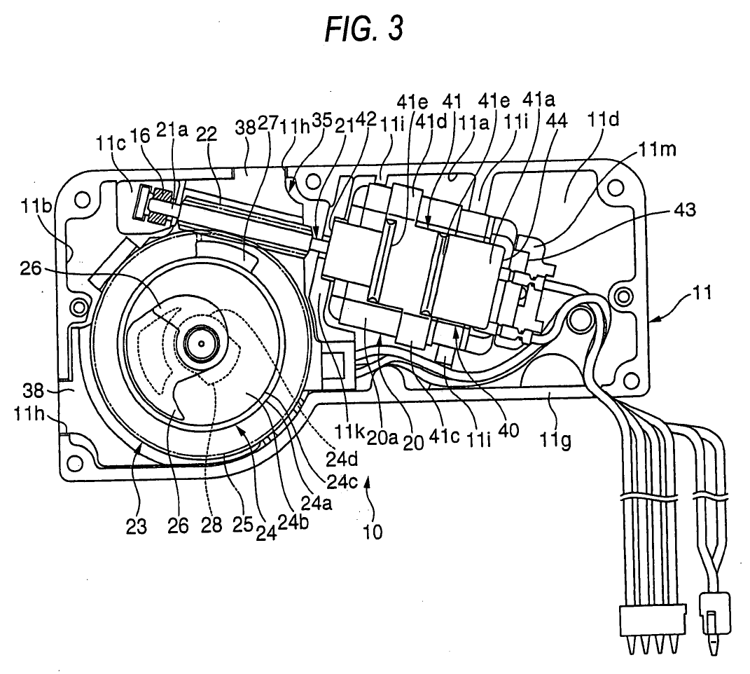

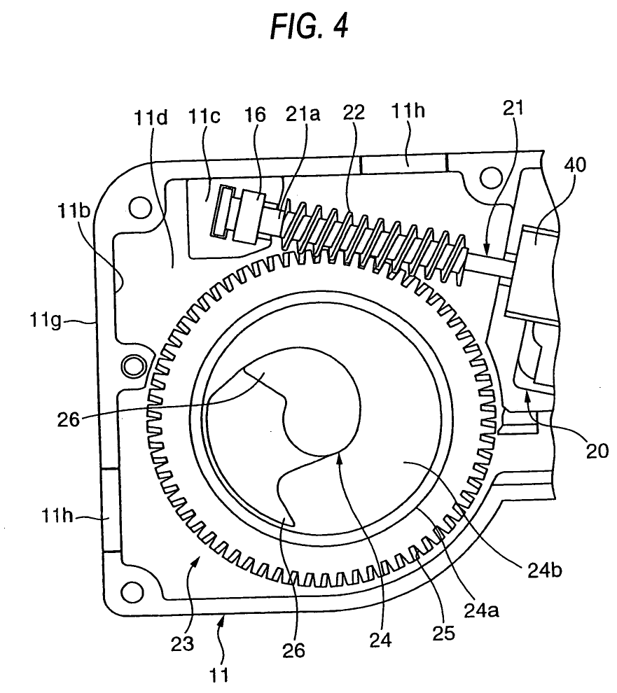

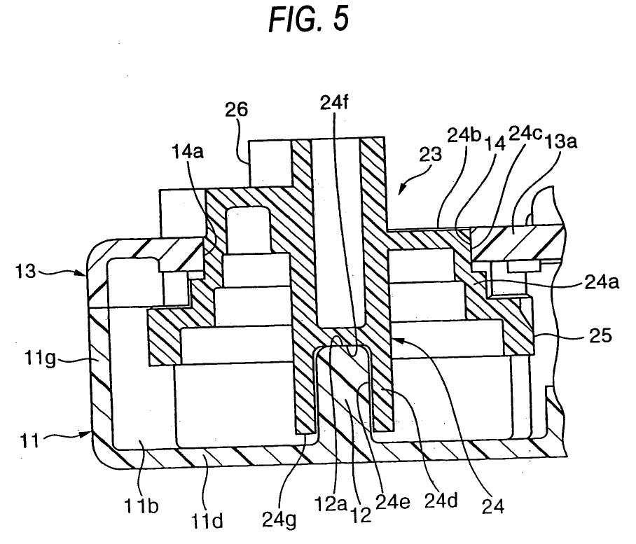

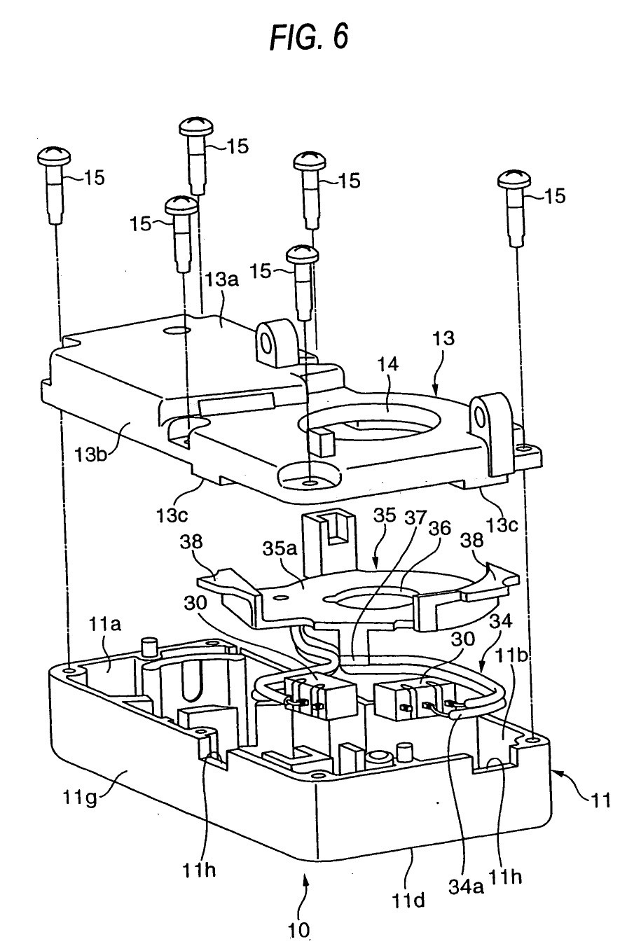

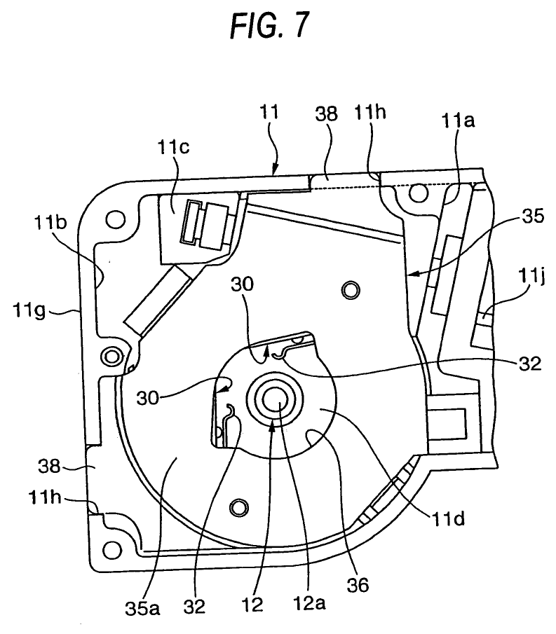

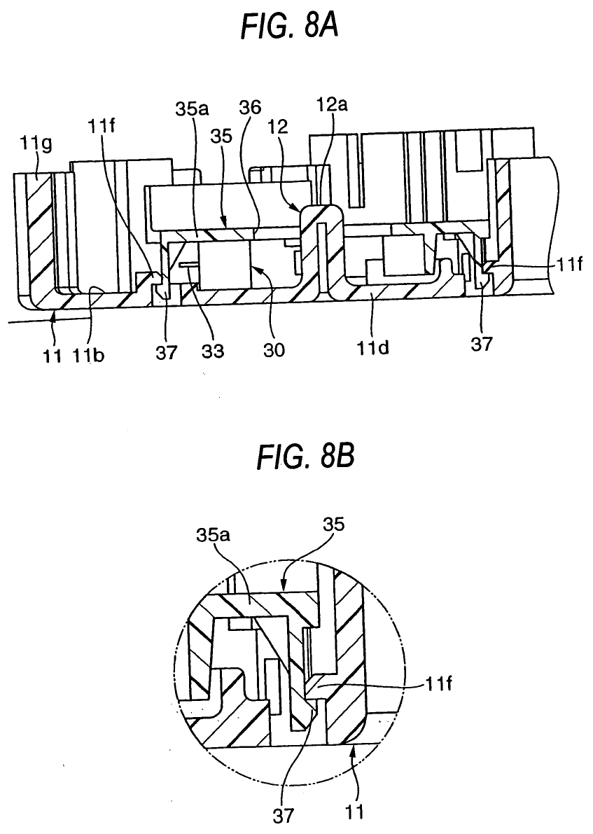

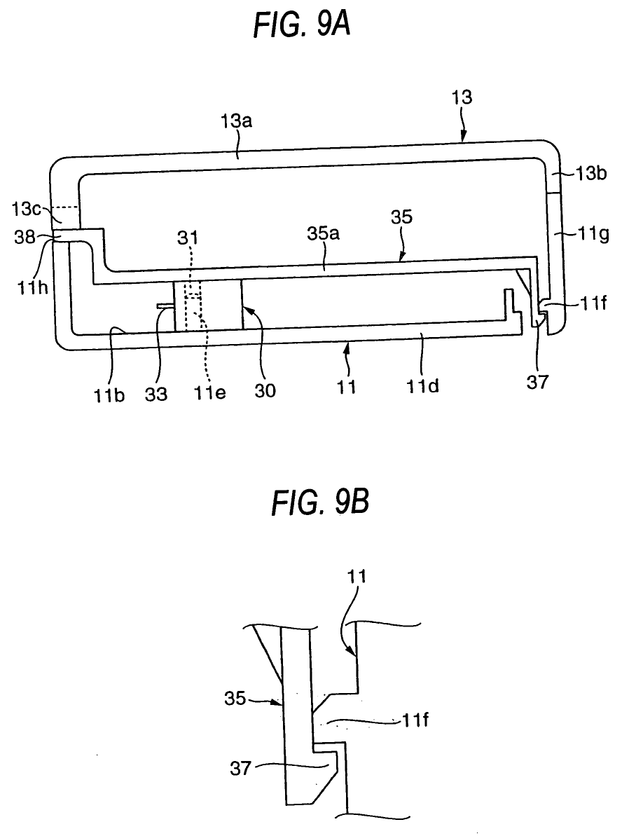

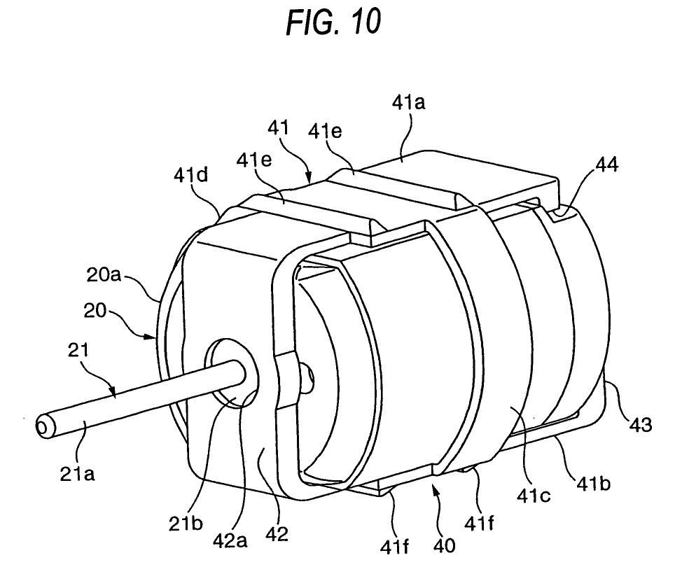

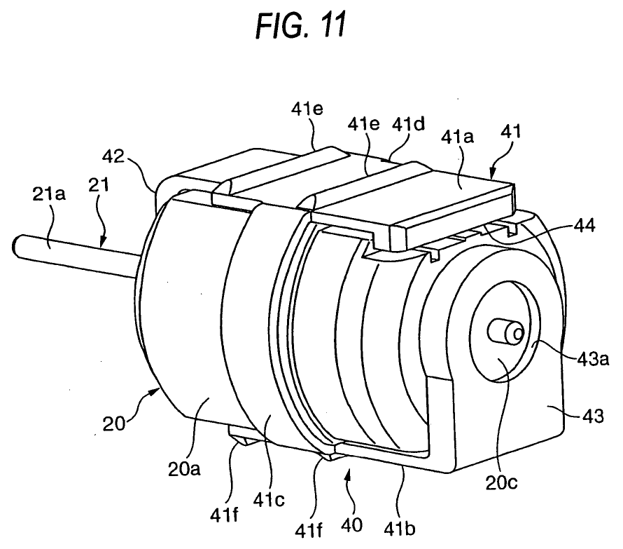

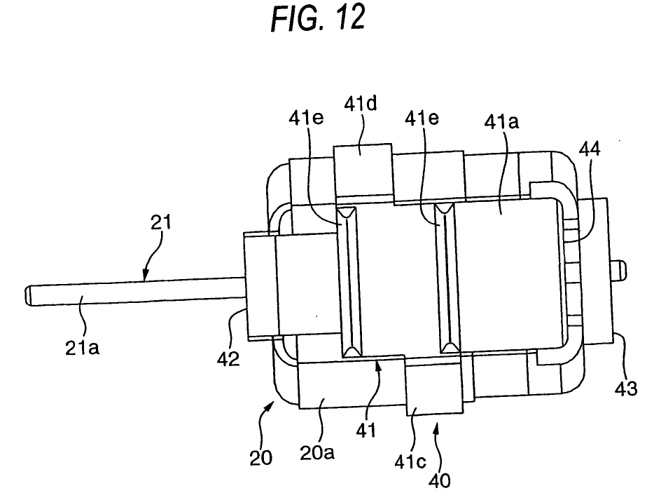

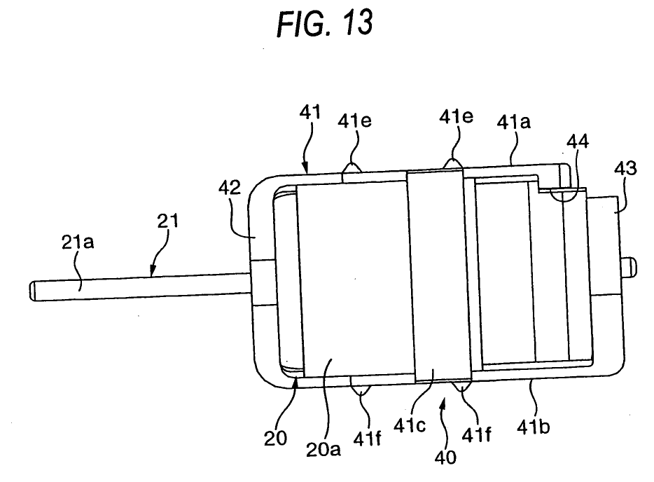

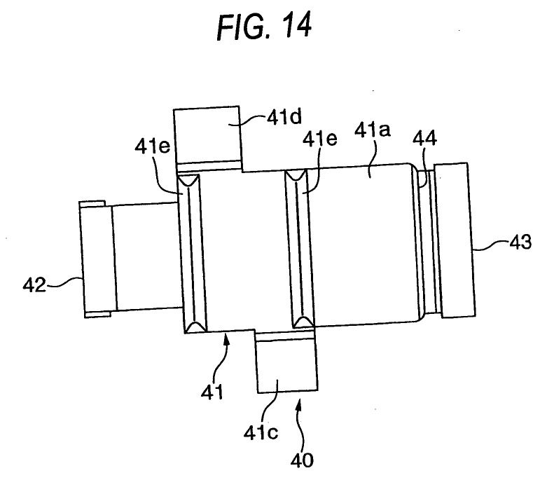

FIG. 1 is an exploded perspective view of a steering lock device according to an embodiment of the invention. FIG. 2 is a cross section of the steering lock device. FIG. 3 is a plan view of the case of the steering lock device. FIG. 4 is an enlarged plan view of the output gear of the steering lock device and its periphery. FIG. 5 is an enlarged cross section of the output gear and its periphery. FIG. 6 is an exploded perspective view showing the relationship between the case, a cover, a switch holder and a limit switch. FIG. 7 is a plan view showing a state where a switch holder is temporarily attached to the case. FIG. 8A is a cross section showing a state where a switch holder is temporarily attached to the case. FIG. 8B is an enlarged cross section of a main part with the switch holder temporarily attached. FIG. 9A is a general explanatory drawing of a mounting state where a switch holder is sandwiched between the case and the cover. FIG. 9B is an enlarged explanatory drawing of the main part in the mounting state. FIG. 10 is a perspective view of a motor used in the steering lock device as seen obliquely from the front of the motor. FIG. 11 is a perspective view of the motor as seen obliquely from the rear of the motor. FIG. 12 is a plan view of the motor. FIG. 13 is a side view of the motor. FIG. 14 is a plan view of an elastic element attached to the motor.

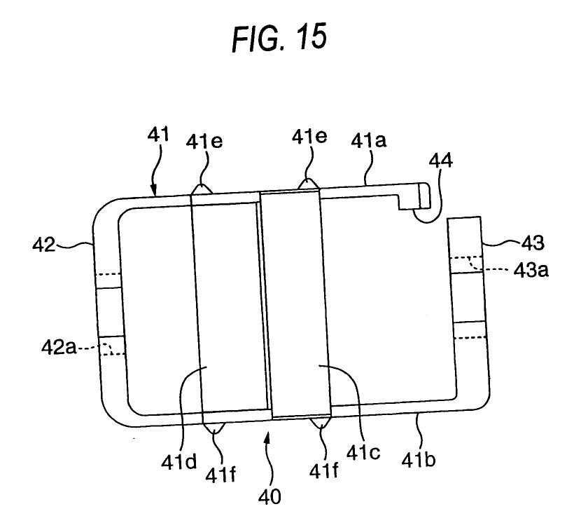

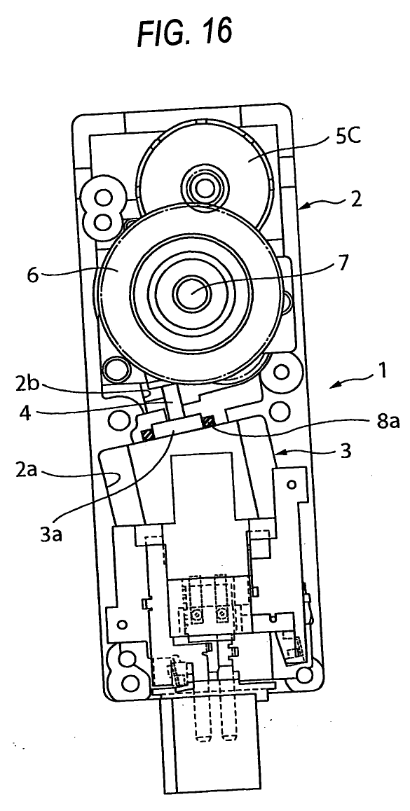

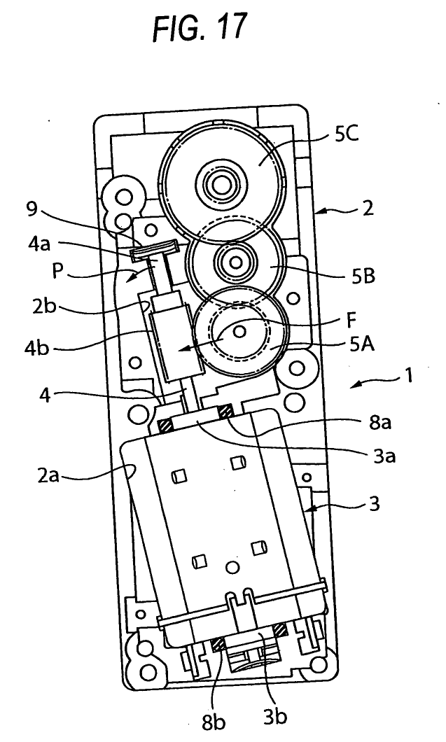

FIG. 15 is a side view of the elastic element.

As shown in FIGS. 1 through 3, a steering lock device (actuator device) 10 includes a box-shaped case 11 made of a synthetic resin having a motor housing unit 11a and a gear housing unit 11b in communication with the motor housing unit 11a, the gear housing unit 11b having a cylindrical spindle 12 integrally protruded thereon, and a cover 13 made of a synthetic resin covering the motor housing unit 11a and the gear housing unit 11b of the case 11 and forming a bearing 14 in the shape of a round hole, the cover clamped and fixed with a screw 15 so as to cover the entire case 11.

A motor 20 is housed in the motor housing unit 11a of the case 11. A tip 21a of its armature shaft (driving shaft) 21 is rotatably supported by a bearing 16 held by a bearing holding part 11c of the gear housing unit 11b. On the tip of the armature shaft 21 is mounted a worm 22, which comes inside the gear housing unit 11b. When an electric current is supplied to the armature coil (not shown) of the armature mounted on the armature shaft 21, the armature is normally rotated or inversely rotated. When the electric current supplied to the armature coil is shut off, an electromagnetic control circuit is formed to cause an electromagnetic control current to flow in the armature coil.

As shown in FIGS. 1 through 5, in the gear housing unit 11b of the case 11 is rotatably housed an output gear 23 made of a synthetic resin driven to rotate while engaged with the worm 22 of the armature shaft 21 of the motor 20. The output gear 23 includes an output shaft 24 forming a spindle, a gear part 25 integrally protruded in the center of the output shaft 24 while being engaged with the worm 22 of the armature shaft 21 of the motor 20, and a pair of output cam parts 26, 26 integrally protruded above a top surface 24b of a large diameter part 24a 15′ (top part) of the output shaft 24. The output cam part 26 is arranged to be exposed outside the bearing 14 in the shape of around hole formed on a ceiling wall 13a of the cover 13 mentioned later. The output cam part 26 is used to lock or unlock the steeling shaft (not shown).

As shown in FIGS. 1 through 5, above the center of the bottom wall 11d of the gear housing unit 11b of the case 11 is integrally protruded a long spindle 12 in the shape of a cylinder. At a small diameter part (bottom part) 24d of the output shaft 24 of the output gear 23 is formed a circular recessed bearing 24e to be fitted to the spindle 12. An inner end surface (bottom surface) 24f of the bearing 24e is arranged on the top surface 12a of the cylindrical spindle 12. The opening end of the bearing 24e, that is, the bottom end 24g of the small diameter part 24d of the output shaft is placed a predetermined clearance from the bottom wall 11d of the case 11. With this configuration, the output shaft 24 of the output gear 23 is supported by the cylindrical spindle 12 in a smoothly rotating fashion.

At a position facing the spindle 12 of the ceiling wall 13a of the cover 13 is formed a bearing 14 in the shape of a round hole. On the inner peripheral surface 14a of the bearing 14 in the shape of a round hole is rotatably supported the outer peripheral surface 24c of the large diameter part 24a of the output shaft 24.

As shown in FIGS. 1, 2 and 5, the gear part 25 of the output gear 23 is integrally formed below the large diameter part 24a of the output shaft 24. As shown in FIGS. 1 and 3, above the outer peripheral surface 24c of the large diameter part 24a of the output shaft 24 is integrally protruded a stopper 27 in the arc-shaped block that is brought into contact with and locked by a stopper (not shown) formed on the inner surface of the ceiling wall 13a of the cover 13. The stopper 27 is integrally protruded in an arc shape along a predetermined width dimension in the perimeter direction from the outer peripheral surface 24c of the large diameter part 24a of the output shaft 24.

As shown in FIG. 3, above the small diameter part 24d of the output shaft 24 is integrally protruded a cam part 28. Inside the gear housing unit 11b of the case 11 facing the cam part 28 is attached, via a switch holder 35 made of a synthetic resin, a pair of limit switches (switch means) 30, 30 turned on/off by the cam part 28 when the output gear 23 has rotated by a predetermined angle.

As shown in FIG. 1 and FIGS. 6 through 9, the pair of limit switches (switch means) 30, 30 for detecting the position of the output gear 23 is arranged to be pressed against the inner surface of the gear housing unit 11b of the case 11 by the switch holder 35 made of a synthetic resin. In other words, as shown in FIGS. 1, 6 and 9, in both sides of the front of each limit switch 30 are respectively formed a pair of engaging holes (engaging parts) 31, 31 that is thorough across the top and bottom surfaces and whose cross section is a circle. On the rear surface of the limit switch 30 is mounted an operation level 32. On the front of each limit switch 30 is protruded a pair of terminals 33, 33. To the terminal 33, the core 34a of a harness 34 can be connected via soldering.

As shown in FIG. 1, at a position facing the pair of engaging holes 31, 31 of each limit switch 30 of the bottom wall 11d of the gear housing unit 11b of the case 11 is integrally protruded a pair of fixing bosses (engaging part for fixing) 11e, 11e to which is fitted and fixed the pair of engaging holes 31, 31 of the limit switch 30.

As shown in FIG. 1 and FIGS. 6 through 9, the switch holder 35 that presses each limit switch 30 against the inner surface of the gear housing unit 11b of the case 11 is formed in the shape of a plate. In the center of its holder main body 35a is formed a hole-like sight glass 36 for viewing each limit switch 30. Below both sides of the holder main body 35a of the switch holder 35 is integrally protruded a pair of temporary-fixing locking claws 37, 37 (locking part for temporary fixing) that is respectively locked to a pair of L-shaped engaging parts 11f, 11f formed on the bottom wall 11d of the case 11. Further, on both sides of the holder main body 35a of the switch holder 35 is protruded a pair of arms (holding parts) 38, 38 in an L shape. On the side wall 11g of the case 11 is provided an engaging recessed part 11h that receives each arm 38. Below the side wall 13b of the cover 13 is protruded an locking projection 13c engaged with each engaging recessed part 11h while sandwiching each arm 38 of the switch holder 35. When each locking projection 13c of the side wall 13b of the cover 13 is fitted to each engaging recessed part 11h of the side wall 11g of the case 11, after the switch holder 35 is temporarily fixed to each engaging part 11f of the case 11, each arm 38 of the switch holder 35 is arranged in a sandwiching 25 fashion between each engaging recessed part 11h and the locking projection 13c of the cover 13.

As shown in FIGS. 1 and 3, at a predetermined position of the inner surface of both walls 13b, 13b of the case 11 facing each other is integrally protruded projections 11i, 11i extending in vertical direction in FIG. 1. Above the bottom wall 11d in the motor housing unit 11a is integrally protruded a pair of projections 11j, 11i extending in parallel with the axis direction of the motor 20.

As shown in FIGS. 10 through 15, an elastic element 40 attached to the motor 20 includes a main body floating part 41 for holding the motor main body (motor yoke part) 20a of the motor 20 and a pair of bearing floating parts 42, 43 for respectively holding the bearings 20b, 20c in front and rear of the armature shaft (driving shaft) 21 of the motor 20. The main body floating part 41 and the pair of bearing floating parts 42, 43 are integrally formed for example by way of a thermoplastic elastomer resin material (elastic member). A notch 44 is formed between the main body floating part 41 and the rear bearing floating part 43. The pair of bearing floating parts 42, 43 is respectively fitted to the bearing holding parts 11k, 11m of the case 11.

As shown in FIGS. 14 and 15, the main body floating part 41 is formed so that the motor main body 20a will be embraced by a top piece 41a, a bottom piece 41b and side pieces 41c, 41d connecting the top piece 41a and the bottom piece 41b. Above the top surface of the top piece 41a is respectively protruded a pair of projections 41e, 41e extending in parallel with the width direction of the motor 20. Below the bottom surface f the bottom piece 41b is protruded a pair of projections 41f, 41f extending in parallel with the width direction of the motor 20.

In the center of the bearing floating parts 42, 43 are respectively formed holes 42a, 43a to be fitted to the bearings 20b, 20c in front and rear of the armature shaft (driving shaft) 21 to rotatably support the same.

The motor 20 to which the elastic element 40 is attached is supported via the bearing holding parts 11k, 11m of the case 11 in a floatable fashion with the pair of bearing floating parts 42, 43 of the elastic element 40 to be fitted to the bearing holding parts 11k, 11m.

The motor 20 is supported in a floatable fashion via a pair of projections 41e, 41e and a pair of projections 41f, 41f respectively formed on the top piece 41a and the bottom piece 41b, between a pair of projections 11j, 11j formed on the bottom wall 11d in the motor housing unit 11a and the inner surface of the ceiling wall 13a.

When a large reactive force from the output gear 23 is acted on the armature shaft 21 via the worm 22, in case the reactive force is a load exceeding the permissible limit of the elastic element 40 supporting the motor 20 in a floatable fashion, the outer side surface of the motor main body 20a comes into contact with each projection 11i integrally protruded above the inner surface of the mutually facing side walls 13b, 13b of the case 11. Thus, the motor 20 is held with in a predetermined angle.

According to the steering lock device 10 of the embodiment, when an electric current is supplied to the armature coil (not shown) of the motor 20, the worm 22 of the armature shaft 21 rotates and the output gear 23 engaged with the worm 22 and the output shaft 24 of the output gear 23 rotate.

When the output gear 23 rotates by a predetermined angle, the cam part 28 integrally protruded above the small diameter part 24d of the output shaft 24 of the output gear 23 presses the operation lever 32 of a pair of limit switches 30, 30 in the OFF state arranged in the gear housing unit 11b of the case 11, thereby turning ON the limit switch 30. When each limit switch is turned ON, a position detection signal is output to the motor thus turning OFF the energization and the electric current supplied to the armature coil is shut off. Even after the limit switch 30 is turned ON, the output gear 23 further rotates by way of delay and coasting. The stopper 27 formed at the large diameter part 24a of the output shaft 24 comes in contact with a stopper (not shown) formed on the inner surface of the ceiling wall 13a of the cover 13, thus halting the output gear 23. At a position where the output gear 23 is halted, the cam part 28 holds each limit switch 30 in the ON state.

As shown in FIG. 1 and FIGS. 6 through 9, in case a pair of limit switches 30, 30 is assembled inside the gear housing unit 11b of the case 11, in the first place, a pair of engaging holes 31, 31 is fitted to each pair of fixing bosses 11e, 11 protruded on the bottom wall 11d of the gear housing unit 11b of the case 11.

As shown in FIGS. 7 and 8, a pair of locking claws 37, 37 of the switch holder 35 for temporary fixing is temporarily fixed to a pair of engaging parts 11f, 11f of the gear housing unit 11b. Next, as shown in FIG. 9, when the cover 13 is attached to the case 11 and the cover 13 is clamped and fixed to the case 11 via a screw 15, the pair of arms 38, 38 of the switch holder 35 is pressed by a pair of locking projections 13c, 13c on the side wall 13b of the cover 13 thus fitted into the pair of engaging recessed parts 11h, 11h of the side wall 11g of the case 11. This causes the pair of arms 38, 38 of the switch holder 35 to be sandwiched between the pair of engaging recessed parts 11h, 11h of the side wall 11g of the case 11 and the pair of locking projections 13c, 13c on the side wall 13b of the cover 13. As a result, it is possible to readily and reliably fix the pair of limit switches 30, 30 between the bottom wall 11d of the gear housing unit 11b of the case 11 and the holder main body 35a of the switch holder 35.

As shown in FIG. 9A, the cover 13 is attached to the case 11, which does without the role of temporary fixing of the pair of temporary-fixing locking claws 37, 37 of the switch holder 35 to the pair of engaging parts 11f, 11f of the gear housing unit 11b f the case 11.

The motor 20 housed in the motor housing unit 11a of the ase 11 supported by the elastic element 40 attached, while embracing the motor 20, between the projections 11i, 11i on the bottom wall 11d and the side wall 11g of the motor housing unit 11a and the inner surface of the ceiling wall 13a of the cover 13. The elastic element 40 that supports the motor 20 in the motor housing unit 11a of the case 11 in a floatable fashion is formed by a main body floating part 41 that holds the motor main body 20a of the motor 20 and a pair of bearing floating parts 42, 43 that respectively holds the bearings 20b, 20c in front and rear of the armature shaft 21 of the motor 20, and the main body floating part 41 and the pair of bearing floating parts 42, 43 are integrally formed by a thermoplastic elastomer resin material. This approach reduces the assembly man-hours and the overall cost as well as reliably supports the entire motor 20 in a floatable fashion by using a simple structure.

With this configuration, it is possible to reliably suppress the war page (deformation) of the armature shaft 21 caused by the reactive force from the output gear 23 engaged with the worm 22 of the armature shaft 21 of the motor 20 or deviation of the motor 20 in the motor housing unit 11a within a predetermined range, thereby reliably preventing malfunction or noise caused by deformation of the armature shaft 21 of the motor 20 or deviation of the motor 20. As a result, it is possible to constantly keep the preferable ratio of engagement of the warm 22 of the armature shaft 21 with the gear part 25 of the output gear 23, thereby providing a high-precision steeling lock device 10 at low cost.

Further, a notch 44 is formed between the main body floating part 41 of the elastic element 40 and the rear bearing floating part 43. This makes it possible to readily and reliably mount the top and bottom pieces 41a, 41b and the side pieces 41c, 41d of the main body floating part 41 of the elastic element 40 to the motor main body 20a of the motor 20, as well as readily and reliably attach the holes 42a, 43a of the pair of bearing floating parts 42, 43 of the elastic element 40 to the bearings 20b, 20c in front and rear of the armature shaft 21.

On the main body floating part 41 of the elastic element 40 are formed a top piece 41a, a bottom piece 41b and side pieces 41c, 41d connecting the top piece 41a and the bottom piece 41b. In the pair of bearing floating part 42, 43 of the elastic element 40 are formed holes 42a, 43a to be fitted to the bearings 20b, 20c that support the armature shaft 21 of the motor 20 in a rotatable fashion. Thus, the motor main body 20a is embraced by the main body floating part 41 and the bearing floating parts 42, 43, thus supporting the motor main body 20a more reliably in a floatable fashion.

Above the top surface of the top piece 41a is protruded a pair of projections 41e, 41e extending in the width direction of the motor main body 20a. Below the bottom surface of the bottom piece 41b is protruded a pair of projections 41f, 41f extending in the width direction of the motor main body 20a. This supports the motor main body 20a more reliably in a floatable fashion between the bottom wall 11d in the motor housing unit 11a and the inner surface of the cover 13.

While an elastic element that supports a motor in a floatable fashion is formed by a thermoplastic elastomer resin material in the foregoing embodiment, a member of another material, such as a rubber, may be used instead. While a steering lock device is described as an actuator device, the embodiment may be applied to any actuator device other than a steering lock device.

What is claimed is:

1. An actuator device comprising:
a case having a cover that covers a motor housing unit and a gear housing unit;
a motor housed in the motor housing unit of the case; and
an output gear rotatably housed in the gear housing unit of the case, the output gear driven to rotate by the driving shaft of the motor;
the actuator device supporting the motor in a floatable fashion within the motor housing unit via an elastic element, wherein
the elastic element includes:
a main body floating part for holding the motor main body of the motor, and
a pair of bearing floating parts for respectively holding the bearings in front and rear of the driving shaft of the motor,
the main body floating part and the pair of bearing floating parts being integrally formed by way of an elastic element.

2. The actuator device according to claim 1, further comprising:
a notch formed between the main body floating part and at least one bearing floating part.

3. The actuator device according to claim 1, further comprising:
a top piece, a bottom piece and side pieces connecting the top piece and the bottom piece formed in the main body floating part, wherein
holes fitted to the bearings that rotatably support the driving shaft of the motor are formed in the pair of bearing floating parts.

4. The actuator device according to claim 3, further comprising:
a pair of projections extending in the width direction of the motor main body of the motor integrally protruded above the top surface of the top piece, and
a pair of projections extending in the width direction of the motor main body of the motor integrally protruded below the bottom surface of the bottom piece.
